(19) United States
(12) Patent Application Publication
(10) Pub. No.: US 2012/0146811 A1
(43) Pub. Date: Jun. 14, 2012

(54) DRIVING ASSISTING SYSTEM, METHOD AND COMPUTER READABLE STORAGE MEDIUM FOR STORING THEREOF

(75) Inventors: Anthony CHOU, New Taipei City (TW); Yen-Ning LEE, New Taipei City (TW); Cheng-Hsuan CHO, Hsinchu County (TW); Tang-Hsien CHANG, Taipei City (TW); Shang-Min YU, Changhua County (TW); Chia-Hung CHUEH, Taipei City (TW)

(73) Assignee: INSTITUTE FOR INFORMATION INDUSTRY, TAIPEI (TW)

(21) Appl. No.: 13/098,496

(22) Filed: May 2, 2011

(30) Foreign Application Priority Data
Dec. 14, 2010 (TW) 099143785

(51) Int. Cl. G08G 1/095; G08G 1/09

(52) U.S. Cl. 340/905; 340/907

(57) ABSTRACT

A driving assisting system includes a traffic signal controller, an RSU, at least one data transmission interface and an OBU. The RSU is electrically connected to the traffic signal controller. The OBU is installed on a vehicle. The traffic signal controller controls a traffic light, which is located at an intersection. The RSU obtains traffic-light information of the traffic light from the traffic signal controller. The OBU receives the traffic-light information through the at least one data transmission interface from the RSU. The OBU generates dynamic vehicle information of the vehicle. The OBU determines if the vehicle will be positioned at a key zone of the intersection when the traffic light switches according to the dynamic vehicle information and the traffic-light information. The OBU responds according to a key zone type of the key zone when the vehicle is positioned at the key zone of the intersection.

### RELATED APPLICATIONS

This application claims priority to Taiwan Application Serial Number 099143785, filed Dec. 14, 2010, which is herein incorporated by reference.

### BACKGROUND

1. Technical Field

The present invention relates to a driving assisting system, method and computer readable storage medium for storing thereof.

2. Description of Related Art

Traffic lights are signaling devices positioned at road intersections, pedestrian crossings and other locations to control competing flows of traffic. When approaching a signalized intersection at high speeds and the light switches to yellow, the Dilemma Zone is the space from the intersection to the point on the road where it may be difficult for the driver to discern whether they should run the yellow light or brake to be safe. Hence, there are lots of studies about light-switching periods of traffic lights for traffic safety.

When a driver drives approaching an intersection, the traffic light installed at which switches to yellow, the driver has to determine if driving through the intersection or not in a limited time. There are many factors (such as visual acuity of the driver, weather or any other factor), which may lead the driver to make dangerous decisions and increase the car accident probability.

To avoid drivers being positioned at Dilemma Zone, time length that the traffic light shows the yellow light is increased to give drivers sufficient time to drive through intersections. However, as time length that the traffic light shows the yellow light increases, the number of vehicles driving through intersections may be reduced. On the other hand, increasing the time length that the traffic light shows the yellow light can raise the number of vehicles driving through the intersection. However, the probability that drivers are positioned at Dilemma Zone would increase, which causes intersections more dangerous. Hence, there is a need to consider both safety and traffic efficiency of intersections.

### SUMMARY

According to one embodiment of this invention, a driving assisting system is provided. The driving assisting system determines if a vehicle will be positioned at a key zone of an intersection, such as Dilemma Zone, Clearance Zone, Stop Zone or other types of key zones, according to vehicle information and traffic light information. Wherein, the OBU responds or generates corresponding warning signals according to the type of the key zone, which the vehicle would be positioned at when the traffic light switches, to avoid signal violation or unsafe driving. The driving assisting system includes a traffic signal controller, a road-side unit (RSU), at least one data transmission interface and an on-board unit (OBU). The RSU is electrically connected to the traffic signal controller. The OBU is installed on a vehicle. The traffic signal controller controls a traffic light. Wherein, the traffic light is located at an intersection. The RSU includes an obtaining module for obtaining traffic-light information of the traffic light from the traffic signal controller. The OBU includes a receiving module, a generating module and an information processing module. The receiving module receives the traffic-light information through the at least one data transmission interface from the RSU. The generating module generates dynamic vehicle information of the vehicle. The information processing module determines if the vehicle will be positioned at a key zone of the intersection when the traffic light switches according to the dynamic vehicle information and the traffic-light information. When the vehicle is positioned at the key zone of the intersection, the information processing module responds according to a key zone type of the key zone.

According to another embodiment of this invention, a driving assisting method is provided. In the driving assisting method, if a vehicle will be positioned at a key zone of an intersection, such as Dilemma Zone, Clearance Zone, Stop Zone or other types of key zones, when the traffic light switches is determined according to vehicle information and traffic light information. The type of the key zone is taken as a factor for responding. The driving assisting method may take the form of a computer program product stored on a computer-readable storage medium having computer-readable instructions embodied in the medium. The driving assisting method includes the following steps: dynamic vehicle information of a vehicle is received. Traffic-light information of a traffic light is received. Wherein, the traffic light is located at an intersection. Determine if the vehicle will be positioned at a key zone of the intersection when the traffic light switches according to the dynamic vehicle information and the traffic-light information. When the vehicle is positioned at the key zone of the intersection, respond according to a key zone type of the key zone.

Above all, the drivers of the vehicles may be noticed for response, or the light-switching period of the traffic light can be adjusted in real time, which can avoid dangers caused by the signal violation or brake slamming. Besides, the present invention is suitable for both fixed and un-fixed time traffic control strategy. Hence, embodiments of this invention can be integrated into the traffic light system nowadays easily.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 illustrates a block diagram of a driving assisting system according to one embodiment of this invention;

FIG. 2 illustrates an embodiment of the driving assisting system in FIG. 1; and

FIG. 3 is a flow diagram of a driving assisting method according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

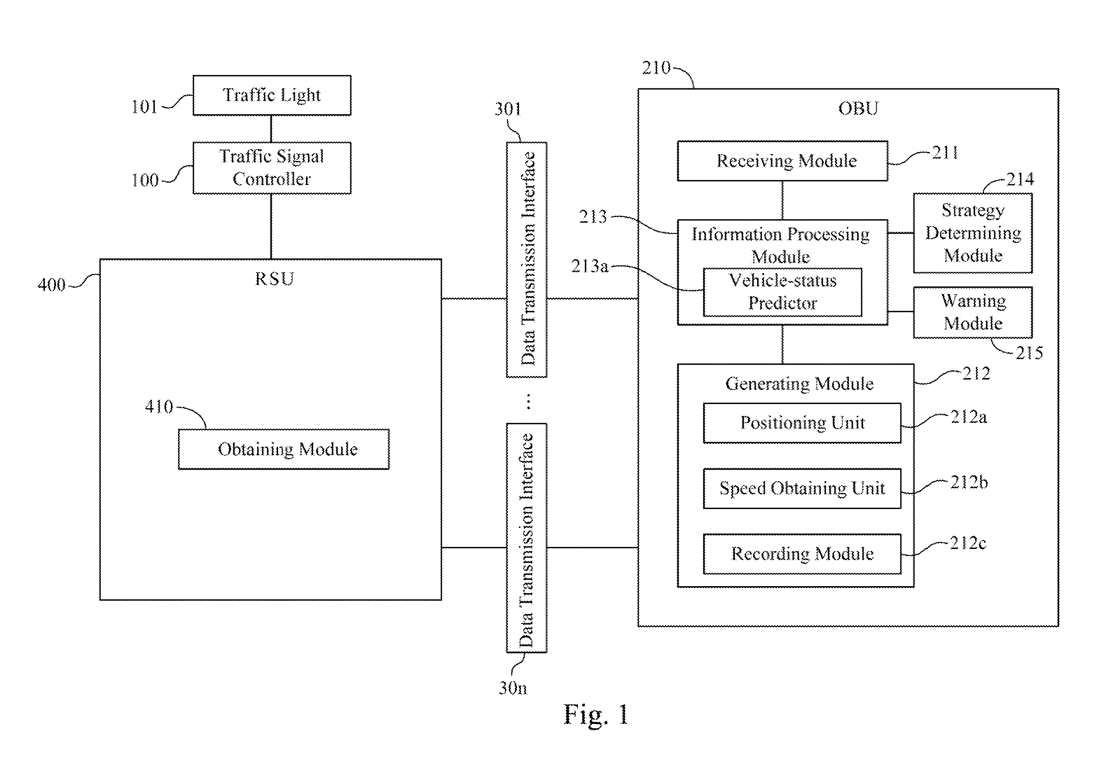

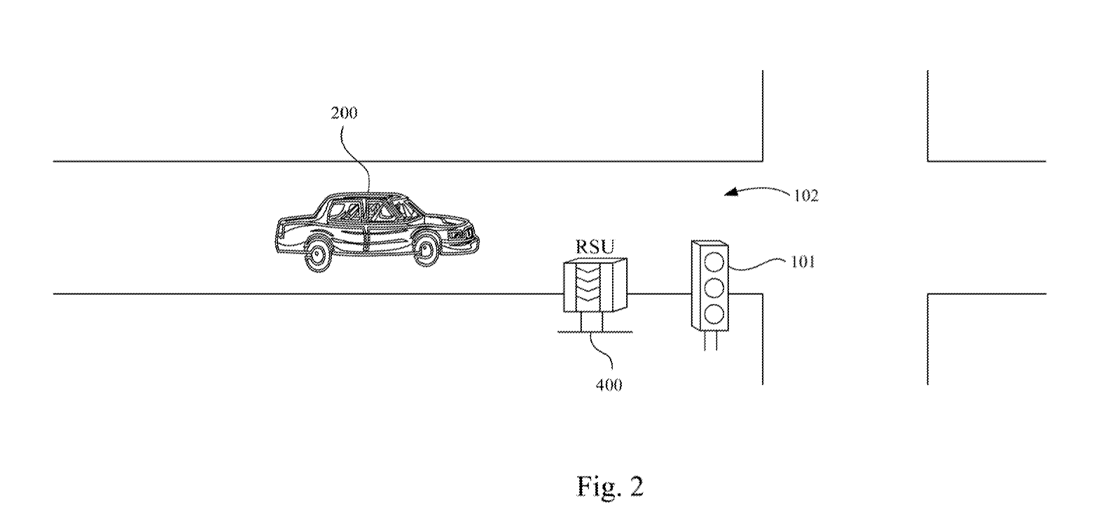

FIG. 1 illustrates a block diagram of a driving assisting system according to one embodiment of this invention. FIG. 2 illustrates an embodiment of the driving assisting system in FIG. 1. The driving assisting system determines if a vehicle will be positioned at a key zone of an intersection according to received vehicle information and traffic light information. Wherein, the OBU responds or generates corresponding warning signals according to the type of the key zone, which the vehicle would be positioned at when the traffic light switches, to avoid signal violation or unsafe driving.

The driving assisting system includes a traffic signal controller 100, an RSU 400, at least one data transmission interface 301, . . . , 30n and an OBU 210. The RSU 400 is electrically connected to the traffic signal controller 100. The OBU 210 is installed on a vehicle 200. The at least one data transmission interface 301, . . . , 30n may utilize Infrared Data (IrDA) interconnection standard, Bluetooth, WiFi, Zigbee, Dedicated short-range communications (DSRC), 3^{rd} generation (3G), 4^{th} generation (4G) and General packet radio service (GPRS) or any other wireless data transmission standard. In addition, the number of the at least one data transmission interface 301, . . . , 30n may be more than one. Hence, different wireless data transmission standards can be utilized by the data transmission interfaces 301, . . . , 30n to avoid data lost.

The traffic signal controller 100 controls a traffic light 101. The RSU 400 includes an obtaining module 410 for obtaining traffic-light information of the traffic light 101 from the traffic signal controller 100. The traffic light 101 is located at an intersection 102 and may include a green light, a yellow light or a red light. The obtained traffic-light information of the traffic light 101 may include a stop line position of the intersection 102, a width of the intersection 102, a gradient of the intersection 102, an initial time of the yellow light, a remaining time of the green light, a length of time for the red light, any other traffic light 101 related information or combination thereof.

The OBU 210 includes a receiving module 211, a generating module 212 and an information processing module 213. The receiving module 211 receives the traffic-light information through the at least one data transmission interface 301, . . . , 30n from the RSU 400. The generating module 212 generates dynamic vehicle information of the vehicle 200. The dynamic vehicle information of the vehicle 200 may include a present speed of the vehicle 200, a present position of the vehicle 200, a length of the vehicle 200, a weight of the vehicle 200, a maximal acceleration of the vehicle 200, a maximal deceleration of the vehicle 200, reaction time of a driver driving the vehicle 200, any other vehicle 200 related information or combination thereof.

The information processing module 213 determines if the vehicle 200 will be positioned at a key zone of the intersection 102, such as Dilemma Zone, Clearance Zone, Stop Zone or other types of key zones, when the traffic light 101 switches according to the dynamic vehicle information and the traffic-light information. The traffic light 101 switching may mean the switching from the green light of the traffic light 101 to the yellow light of the traffic light 101. In other embodiments, the traffic light 101 switching may be other types of light switching, which should not be limited in this disclosure. When the OBU 210 determines that the vehicle 200 is positioned at the key zone of the intersection 102 when the traffic light 101 switches, the information processing module 213 responds according to a key zone type of the key zone to avoid signal violation or unsafe driving. Wherein, when the vehicle 200 is positioned at the key zone of the intersection 102, the key zone type of which is Dilemma Zone, when the traffic light 101 switches to the yellow light, the driver of the vehicle 200 may not have enough time to decide to stop the vehicle 200 or drive the vehicle 200 passing through the intersection 102 in time, which may cause that the driver of the vehicle 200 violates the signal of the traffic light 101. When the vehicle 200 is positioned at the key zone of the intersection 102, the key zone type of which is Stop Zone, when the traffic light 101 switches to the yellow light, the driver of the vehicle 200 may not pass through the intersection 102 in time even if he drives with the maximal speed. Hence, the OBU may generate a warning signal to notice the driver of the vehicle 200 to slow down. When the vehicle 200 is positioned at the key zone of the intersection 102, the key zone type of which is Clearance Zone, when the traffic light 101 switches to the yellow light, the driver of the vehicle 200 may have enough time to pass through the intersection 102. Hence, the OBU may generate a notice message to notice the driver of the vehicle 200 to drive through the intersection 102. Therefore, the information processing module 213 can predict the key zone type on real time to warn the driver of the vehicle 200 or adjust the light-switching period of the traffic light 100, which can reduce the car accident probability caused by the signal violation or slamming the brake of the vehicle 200.

In one embodiment of this invention, when the information processing module 213 determines that the vehicle 200 is positioned at the key zone of the intersection 102 when the traffic light 101 switches, the OBU 210 may generate a corresponding warning signal to notice the driver of the vehicle 200. Hence, the OBU 210 may further include a warning module 215. When the information processing module 213 determines that the vehicle 200 is positioned at the key zone of the intersection when the traffic light 101 switches, the warning module 215 triggers the OBU 210 to generate a warning signal corresponding to the key zone type. Wherein, the generated warning signal may include a warning sound, a warning light signal or any other type of warning signal. Therefore, the probability of the car accident, which is caused by the signal violation or slamming the brake of the vehicle 200, can be reduced by warning the driver of the vehicle 200 utilizing the warning signal, and the intersection 102 can become safer.

In another embodiment of this invention, when the traffic signal controller 100 controls the traffic light utilizing an un-fixed time traffic control strategy, the light-switching period of the traffic light 101 can be adjusted. Hence, the OBU 210 may further include a strategy determining module 214. When the information processing module 213 determines that the vehicle 200 is positioned at the key zone of the intersection 101 when the traffic light 101 switches, the strategy determining module 214 determines if the traffic signal controller 100 controls the traffic light 101 utilizing an un-fixed time traffic control strategy. Wherein, the un-fixed time traffic control strategy may be Adaptive Signal Control strategy, Dynamic Timing Computation strategy, Dynamic Table Look-Up strategy, Full-actuated Signal Control strategy, Semi-actuated Signal Control strategy or any other un-fixed time traffic control strategy. Wherein when the strategy determining module 214 determines that the traffic signal controller 100 controls the traffic light 101 utilizing the un-fixed time traffic control strategy, the OBU 210 transmits a period-adjusting signal to the RSU 400 through the at least one data transmission interface 301, . . . , 30n, such that the RSU 400 request the traffic signal controller 100 to adjust a light-switching period of the traffic light 101. Wherein, the light-switching period of the traffic light 101 may be extended to postpone the initial time of the yellow light of the traffic light 101, such that the vehicle 200 may have enough time to pass through the intersection 102. In another embodiment, the light-switching period of the traffic light 101 may be shortened to advance the initial time of the yellow light of the traffic light 101, such that the driver of the vehicle 200 may see the yellow light of the traffic light 101 earlier to stop the vehicle 200, which can prevent the vehicle 200 from positioning at Dilemma Zone. Therefore, the driver of the vehicle 200 may not violate the signal of the traffic light 101 and it is safer at the intersection 102.

The position of the vehicle 200 at the initial time of the yellow light of the traffic light 101 may be predicted by the information processing module 213 for the key zone related determination. Hence, the information processing module 213 may include a vehicle-status predictor 213a. The vehicle-status predictor 213a predicts a position of the vehicle at the initial time of the yellow light of the traffic light 101 according to the dynamic vehicle information and the traffic-light information. Wherein, the vehicle-status predictor utilizes Kalman Filter, Extended Kalman Filter, Recursive Least Square method, Markov Chain or Artificial NeuralNetwork (ANN) to predict the position of the vehicle. Then, the vehicle-status predictor 213a determines if the position of the vehicle 200 at the initial time of the yellow light is at the key zone of the intersection 102.

In one embodiment of this invention, the information processing module 213 may determine if the vehicle will be positioned at the key zone of the intersection 102 when the traffic light 101 switches according to the present position and the present speed of the vehicle 200. Hence, the generating module 212 may include a positioning unit 212a and a speed obtaining unit 212b. The positioning unit 212a generates a present position of the vehicle 200. The positioning unit 212a may utilize Global Positioning System (GPS), Assisted Global Positioning System (AGPS), Wi-Fi Positioning System or any other positioning method to generate the present position of the vehicle 200. The speed obtaining unit 212b obtains a present speed of the vehicle 200. Wherein, the speed obtaining unit 212b may utilize the present position of the vehicle 200 to calculate the present speed of the vehicle 200. In addition, the speed obtaining unit 212b may obtain the present speed of the vehicle 200 from the speedometer of the vehicle 200. In other embodiment, the speed obtaining unit 212b may obtain the present speed of the vehicle 200 utilizing other methods, which should not be limited in this invention. Then, the generating module 212 may generate the dynamic vehicle information of the vehicle 200, which include the present position and the present speed of the vehicle 200, to provide to the information processing module 213.

In another embodiment, the information processing module 213 may determine if the vehicle will be positioned at the key zone of the intersection 102 when the traffic light 101 switches according to the present position; the present speed and the driven information of the vehicle of the vehicle 200. Hence, the generating module 212c may further include a recording module 212c for recording driven information of the vehicle 200. The driven information may include a length of the vehicle 200, a weight of the vehicle 200, a maximal acceleration of the vehicle 200, a maximal deceleration of the vehicle 200, reaction time of a driver driving the vehicle 200, any other driven related information or combination thereof. Then, the generating module 212 may generate the dynamic vehicle information of the vehicle 200, which include the present position, the present speed and the driven information of the vehicle 200, to provide to the information processing module 213, which can raise the determination accuracy of the information processing module 213.

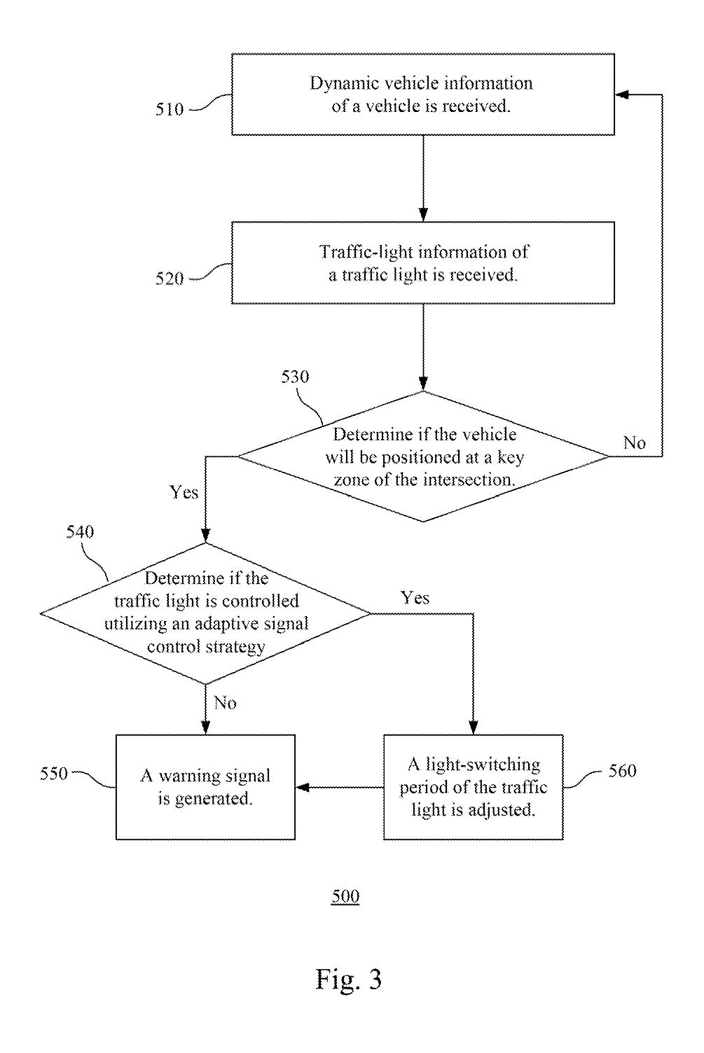

FIG. 3 is a flow diagram of a driving assisting method according to another embodiment of this invention. In the driving assisting method, when a vehicle will be positioned at a key zone of an intersection, such as Dilemma Zone, Clearance Zone, Stop Zone or other types of key zones, when the traffic light switches is determined according to vehicle information and traffic light information. The type of the key zone is taken as a factor for responding. The driving assisting method may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The driving assisting method 500 includes the following steps:

In step 510, dynamic vehicle information of a vehicle is received. Wherein, the dynamic vehicle information of the vehicle may include a present speed of the vehicle, a present position of the vehicle, a length of the vehicle, a weight of the vehicle, a maximal acceleration of the vehicle, a maximal deceleration of the vehicle, reaction time of a driver driving the vehicle, any other vehicle related information or combination thereof. Wherein, the dynamic vehicle information of the vehicle may be received (step 510) through at least one data transmission interface or any other electric signal. The at least one data transmission interface may utilize IrDA interconnection standard, Bluetooth, WiFi, Zigbee, DSRC, 3G, 4G and GPRS or any other wireless data transmission standard. In addition, the number of the at least one data transmission interface may be more than one. Hence, different wireless data transmission standards can be utilized by the data transmission interfaces to avoid data lost.

In step 520, traffic-light information of a traffic light is received. The traffic light is located at an intersection and may include a green light, a yellow light or a red light. The traffic-light information of the traffic light may include a stop line position of the intersection, a width of the intersection, a gradient of the intersection, an initial time of the yellow light, a remaining time of the green light, a length of time for the red light, any other traffic light related information or combination thereof. In one embodiment, when the dynamic vehicle information of a vehicle is received (step 510), the step of receiving the traffic-light information of the traffic light (step 520) may be triggered. In another embodiment, when the traffic-light information of the traffic light is received (step 520), the step of receiving the dynamic vehicle information of a vehicle (step 510) may be triggered. In other embodiments, the executing sequence of step 510 and step 520 may be varied, which should not be limited in this disclosure. In addition, the traffic-light information of the traffic light may be received (step 520) through at least one data transmission interface or any other electric signal.

In step 530, determine if the vehicle will be positioned at a key zone of the intersection when the traffic light switches according to the dynamic vehicle information and the traffic-light information. The key zone of the intersection may be Dilemma Zone, Clearance Zone, Stop Zone or other types of key zones of the intersection. Wherein, the position of the key zone of the intersection can be calculated in real time according to the dynamic vehicle information of the vehicle and be taken as a factor for the determination of step 530. In addition, the determination of step 530 may be executed by an OBU installed on the vehicle or RSU installed around the traffic light. In other embodiments, the determination of step 530 may be executed by other electrical devices, which should not be limited in this disclosure.

In step 550, when the vehicle is positioned at the key zone of the intersection when the traffic light switches, an OBU installed on the vehicle may be triggered to generate a warning signal corresponding to the key zone type to notice a driver of the vehicle. Therefore, the probability of the car accident, which is caused by the signal violation or slamming the brake of the vehicle, can be reduced by warning the driver of the vehicle utilizing the warning signal, and the intersection can become safer.

In another embodiment of this invention, when the traffic light is controlled utilizing an un-fixed time traffic control strategy (such as Adaptive Signal Control strategy, Dynamic Timing Computation strategy, Dynamic Table Look-Up strategy, Full-actuated Signal Control strategy, Semi-actuated Signal Control strategy or any other un-fixed time traffic control strategy), the light-switching period of the traffic light can be adjusted. Hence, the driving assisting method 500 may further include step 540 for determining if the traffic light is controlled utilizing an un-fixed time traffic control strategy. When the traffic light is not controlled utilizing an un-fixed time traffic control strategy, a warning signal is generated (step 550). In step 560, when the traffic light is controlled utilizing an un-fixed time traffic control strategy, a light-switching period of the traffic light is adjusted, and a warning signal is generated. Wherein, step 560 may be executed by extending the light-switching period of the traffic light to postpone the initial time of the yellow light of the traffic light, such that the vehicle may have enough time to pass through the intersection. In another embodiment, step 560 may be executed by shortening the light-switching period of the traffic light to advance the initial time of the yellow light of the traffic light, such that the driver of the vehicle may see the yellow light of the traffic light earlier to stop the vehicle, which can prevent the vehicle from positioning at Dilemma Zone. Therefore, the driver of the vehicle may not violate the signal of the traffic light and the intersection may become safer. Besides, when the light-switching period of the traffic light is adjusted (step 560), an adjusting-noticing signal may be transmitted to a traffic signal controller, which controls another neighboring traffic light. Then, the traffic signal controller may adjust the light-switching period of the neighboring traffic light, which may avoid the traffic jam caused by the light-switching period adjustment in step 560.

In addition, step 530 may be executed by predicting a position of the vehicle at the initial time of the yellow light according to the dynamic vehicle information and the traffic-light information. Then, determination in step 530 can be made through determining if the position of the vehicle at the initial time of the yellow light is at the key zone of the intersection. Wherein, the position of the vehicle at the initial time of the yellow light may be predicted utilizing Kalman Filter, Extended Kalman Filter, Recursive Least Square method, Markov Chain, ANN or any other prediction algorithm.

Above all, the drivers of the vehicles may be noticed for response, or the light-switching period of the traffic light can be adjusted in real time, which can avoid dangers caused by the signal violation or brake slamming. Besides, the present invention is suitable for both fixed and un-fixed time traffic control strategy. Hence, embodiments of this invention can be integrated into the traffic light system nowadays easily.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A driving assisting system comprising:
a traffic signal controller for controlling a traffic light located at an intersection;
a road-side unit (RSU) electrically connected to the traffic signal controller, wherein the RSU comprises:
an obtaining module for obtaining traffic-light information of the traffic light from the traffic signal controller;
at least one data transmission interface; and
an on-board unit (OBU) installed on a vehicle, wherein the OBU comprises:
a receiving module for receiving the traffic-light information through the at least one data transmission interface from the RSU;
a generating module for generating dynamic vehicle information of the vehicle; and
an information processing module for determining if the vehicle will be positioned at a key zone of the intersection when the traffic light switches according to the dynamic vehicle information and the traffic-light information, and for responding according to a key zone type of the key zone when the vehicle is positioned at the key zone of the intersection.

2. The driving assisting system of claim 1, wherein the OBU further comprises:
a warning module for triggering the OBU to generate a warning signal corresponding to the key zone type when the vehicle is positioned at the key zone of the intersection.

3. The driving assisting system of claim 1, wherein the OBU further comprises:
a strategy determining module for determining if the traffic signal controller controls the traffic light utilizing an un-fixed time traffic control strategy when the vehicle is positioned at the key zone of the intersection,
wherein when the strategy determining module determines that the traffic signal controller controls the traffic light utilizing the un-fixed time traffic control strategy, the OBU transmits a period-adjusting signal to the RSU through the at least one data transmission interface, such that the RSU request the traffic signal controller to adjust a light-switching period of the traffic light.

4. The driving assisting system of claim 1, wherein the traffic light comprises a yellow light, the traffic-light information of the traffic light comprises an initial time of the yellow light, the information processing module comprises:
a vehicle-status predictor for predicting a position of the vehicle at the initial time of the yellow light according to the dynamic vehicle information and the traffic-light information and determining if the position of the vehicle at the initial time of the yellow light is at the key zone of the intersection.

5. The driving assisting system of claim 4, wherein the vehicle-status predictor utilizes Kalman Filter, Extended Kalman Filter, Recursive Least Square method, Markov Chain or Artificial NeuralNetwork (ANN) to predict the position of the vehicle at the initial time of the yellow light.

6. The driving assisting system of claim 1, wherein the generating module comprises:
a positioning unit for generating a present position of the vehicle; and
a speed obtaining unit for obtaining a present speed of the vehicle,
wherein the dynamic vehicle information comprises the present position of the vehicle and the present speed of the vehicle.

7. The driving assisting system of claim 1, wherein the generating module comprises:
a positioning unit for generating a present position of the vehicle;
a speed obtaining unit for obtaining a present speed of the vehicle; and
a recording module for recording driven information of the vehicle,
wherein the dynamic vehicle information comprises the present position of the vehicle, the present speed of the vehicle and the driven information of the vehicle.

8. The driving assisting system of claim 1, wherein number of the at least one data transmission interface is more than one.

9. The driving assisting system of claim 8, wherein the data transmission interfaces transmit data utilizing standards selected from Infrared Data (IrDA) interconnection standard, Bluetooth, WiFi, Zigbee, Dedicated short-range communications (DSRC), 3^{rd} generation (3G), 4^{th} generation (4G) and General packet radio service (GPRS).

10. A driving assisting method comprising:
receiving dynamic vehicle information of a vehicle;
receiving traffic-light information of a traffic light, wherein the traffic light is installed at an intersection;
determining if the vehicle will be positioned at a key zone of the intersection when the traffic light switches according to the dynamic vehicle information and the traffic-light information; and
responding according to a key zone type of the key zone when the vehicle is positioned at the key zone of the intersection.

11. The driving assisting method of claim 10, wherein the dynamic vehicle information or the traffic-light information is received through at least one data transmission interface.

12. The driving assisting method of claim 10, wherein number of the at least one data transmission interface is more than one, and the data transmission interfaces transmit data utilizing standards selected from IrDA interconnection standard, Bluetooth, WiFi, Zigbee, DSRC, 3G, 4G and GPRS.

13. The driving assisting method of claim 10 further comprising:
triggering an OBU installed on the vehicle to generate a warning signal corresponding to the key zone type when the vehicle is positioned at the key zone of the intersection.

14. The driving assisting method of claim 10 further comprising:
determining if the traffic light is controlled utilizing an un-fixed time traffic control strategy; and
when the traffic light is controlled utilizing the un-fixed time traffic control strategy, adjusting a light-switching period of the traffic light.

15. The driving assisting method of claim 14 further comprising:
when the light-switching period of the traffic light is adjusted, transmitting an adjusting-noticing signal to a traffic signal controller, which controls another traffic light.

16. The driving assisting method of claim 10, wherein the traffic light comprises a yellow light, the traffic-light information of the traffic light comprises an initial time of the yellow light, and the step of determining if the vehicle will be positioned at the key zone of the intersection according to the dynamic vehicle information and the traffic-light information comprises:
predicting a position of the vehicle at the initial time of the yellow light according to the dynamic vehicle information and the traffic-light information; and
determining if the position of the vehicle at the initial time of the yellow light is at the key zone of the intersection.

17. The driving assisting of claim 16, wherein the position of the vehicle at the initial time of the yellow light is predicted utilizing Kalman Filter, Extended Kalman Filter, Recursive Least Square method, Markov Chain or ANN.

18. The driving assisting method of claim 10, wherein the dynamic vehicle information comprises a present speed of the vehicle, a present position of the vehicle, a length of the vehicle, a weight of the vehicle, a maximal acceleration of the vehicle, a maximal deceleration of the vehicle or reaction time of a driver driving the vehicle.

19. The driving assisting method of claim 10, wherein the traffic light comprise a green light, a yellow light or a red light, the traffic-light information comprises a width of the intersection, at which the traffic light is installed, a gradient of the intersection, an initial time of the yellow light, a remaining time of the green light or a length of time for the red light.

20. The driving assisting method of claim 10, wherein when the vehicle is positioned at a key zone of the intersection is determined by an OBU installed on the vehicle or a RSU installed close to the traffic light.

21. A computer readable storage medium with a computer program to execute a driving assisting method, wherein the driving assisting method comprises:
receiving dynamic vehicle information of a vehicle;
receiving traffic-light information of a traffic light, wherein the traffic light is installed at an intersection;
determining if the vehicle will be positioned at a key zone of the intersection when the traffic light switches according to the dynamic vehicle information and the traffic-light information; and
responding according to a key zone type of the key zone when the vehicle is positioned at the key zone of the intersection.
